(19) United States
(12) Patent Application Publication
(10) Pub. No.: US 2010/0251554 A1
(43) Pub. Date: Oct. 7, 2010

(54) KNIFE ASSEMBLY

(75) Inventor: Yu-Chang CHIEN, Caotun Township (TW)

Correspondence Address: RABIN & Berdo, PC, 1101 14TH STREET, NW, SUITE 500, WASHINGTON, DC, 20005, US

(73) Assignee: Reao International Group Co., Ltd., Caotun Township (TW)

(21) Appl. No.: 12/417,914

(22) Filed: Apr. 3, 2009

(51) Int. Cl. B26B 9/00

(52) U.S. Cl. 30/346

(57) ABSTRACT

A knife assembly is formed by a blade provided for cutting an object and a handle provided for holding a knife. Small grooves are engraved on a surface of the blade and disposed equidistantly from each other on a small section of the surface of the blade, and upper and lower ends of the grooves are extended to a knife back and a blade edge, such that if the knife is used for cutting an object, an airflow is produced outside the surface of the blade, and thus the cut object will not be attached or adhered onto the surface of the blade, so as to achieve the effect of completing the cutting operation smoothly and successfully.

### BACKGROUND OF THE INVENTION

1. Field of the Invention

The present invention relates to a knife assembly, in particular to a knife formed by integrating a blade and a handle, and a plurality of small grooves are engraved on a surface of the blade and disposed equidistantly from each other on a small section of the surface of the blade, and upper and lower ends of the small grooves are extended to a knife back and a blade edge, such that if the knife is used for cutting an object, the cut slices will not be attached or adhered onto the surface of the blade, so as to achieve the effect of completing the cutting smoothly and successfully.

2. Description of the Related Art

Conventional knife A generally comes with a blade 1 having flat surfaces A1 on both sides, and thus most users have experience on cutting an object B such as a piece of meat B1 which is still frozen, and the cut slices of the meat B1 are attached onto the flat surfaces A1 of the blade 1 (as shown in FIG. 1). If the piece of meat B1 is defrosted and the meat is elastic, the cut slices will be adhered onto the flat surfaces A1 of the blade 1 (as shown in FIG. 2). Obviously, the attached or adhered slices give rise to an inconvenient cutting process, and users have to remove the attached or adhered slices of the meat B1 before cutting another slice, and thus the whole cutting process takes much more time.

### SUMMARY OF THE INVENTION

In view of the aforementioned shortcoming of a conventional knife, the inventor of the present invention provides an improved knife assembly to overcome the shortcoming of the prior art.

Therefore, it is a primary objective of the present invention to provide a knife assembly comprising a blade provided for cutting an object and a handle provided for holding a knife. Small grooves are engraved on a surface of the blade and disposed equidistantly from each other in a plurality of small sections on the surface of the blade, and upper and lower ends of the grooves are extended to a knife back and a blade edge, such that if the knife is used for cutting an object, an airflow is produced outside the surface of the blade, and thus the cut slices of the object will not be attached or adhered onto the surface of the blade, so as to achieve the effect of completing a cutting operation smoothly and successfully.

### BRIEF DESCRIPTION OF THE DRAWINGS

FIG. 1 is a schematic view of a conventional knife;

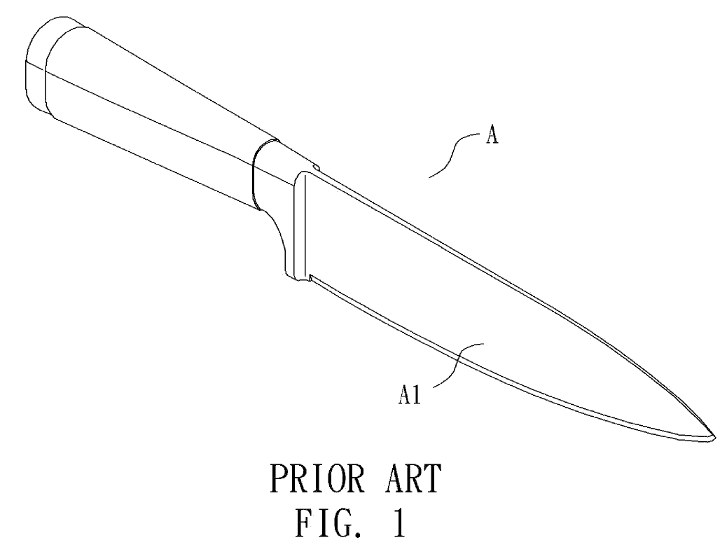

FIG. 2 is a schematic view of operating a conventional knife;

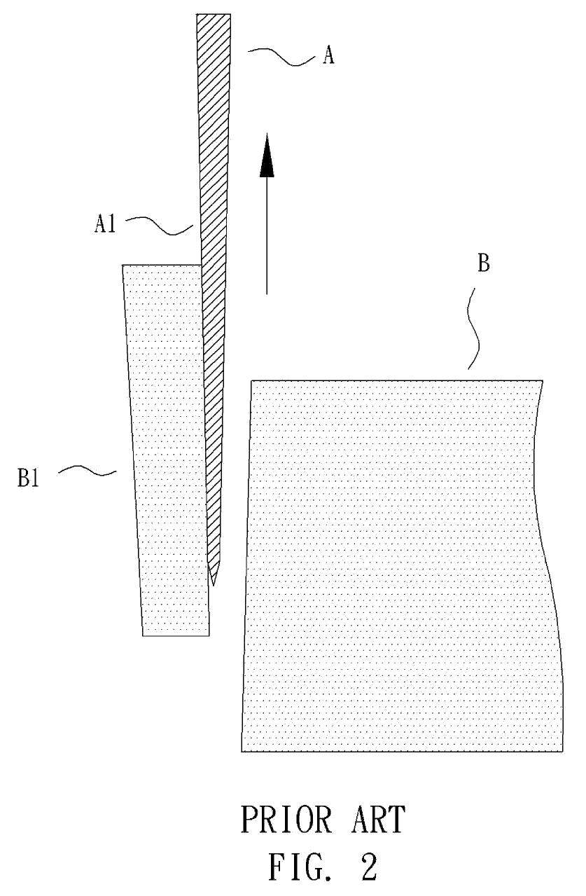

FIG. 3 is a perspective view of a knife assembly of the present invention;

FIG. 4 is a partially enlarged view of a knife assembly of the present invention;

FIG. 5 is a first schematic view of a knife assembly of the present invention;

FIG. 6 is a second schematic view of a knife assembly of the present invention;

FIG. 7 is a first schematic view of operating a knife of the present invention; and

FIG. 8 is a second schematic view of operating a knife of the present invention.

### DETAILED DESCRIPTION OF THE PREFERRED EMBODIMENTS

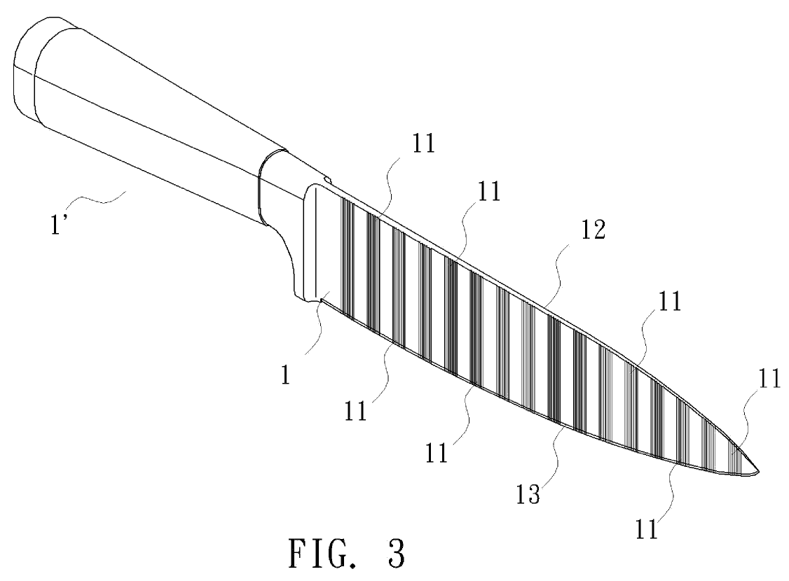

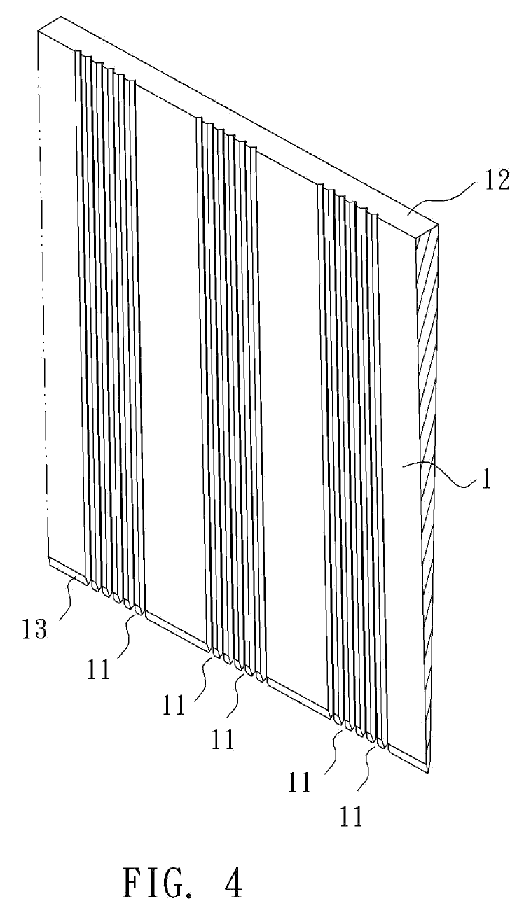

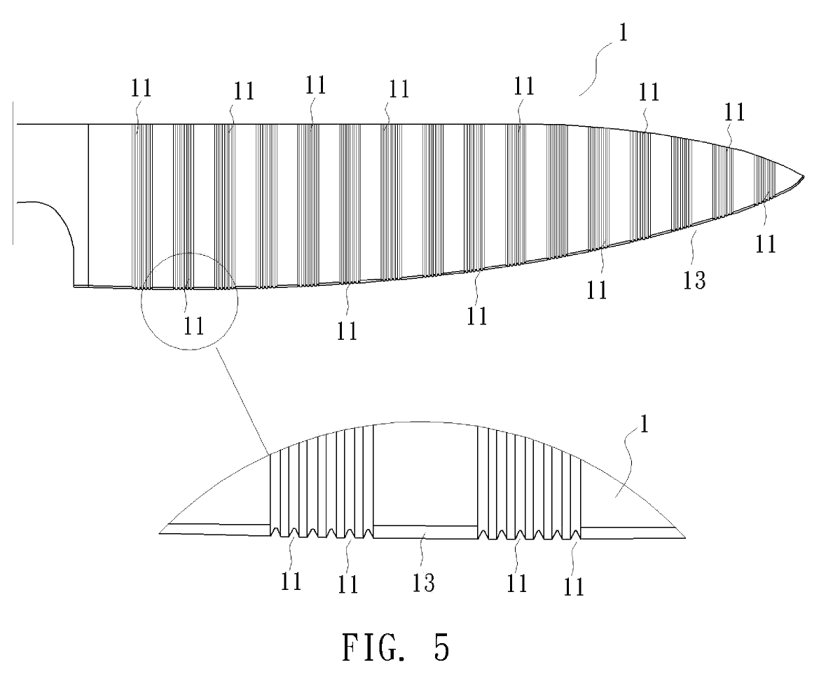

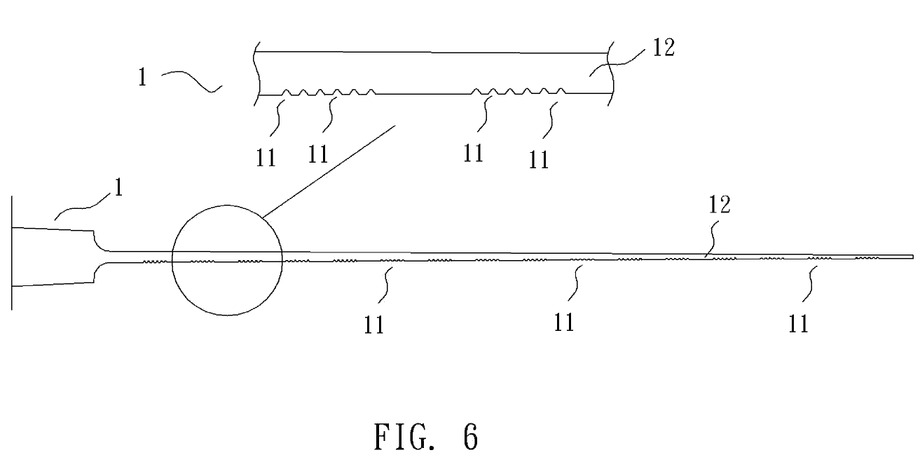

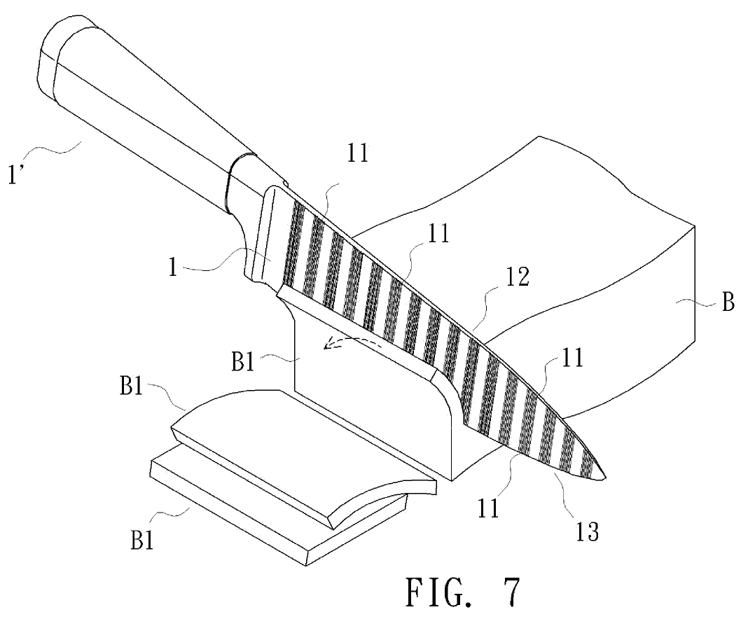

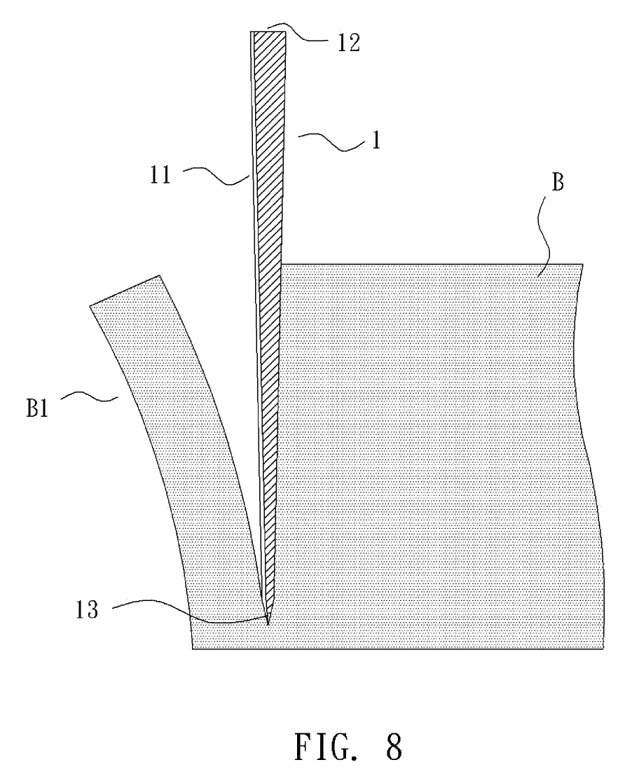

With reference to FIGS. 3 to 6 for the detailed description of a knife assembly in accordance with the present invention, the knife assembly comprises a blade 1 used for cutting an object, and a handle 1′ used for holding a knife, wherein a plurality of small grooves 11 are engraved onto a surface of the blade 1 and disposed equidistantly from each other on a plurality of small sections of the blade 1, and upper and lower ends of the small grooves 11 are extended to a knife back 12 and a blade edge 13, such that if the knife is used for cutting an object (as shown in FIGS. 7 and 8), the plurality of small grooves 11 having the interval apart from each other and disposed on a plurality of small sections of the blade 1, and the upper and lower ends of the small grooves being extended to the knife back 12 and the blade edge 13 are provided for producing an airflow outside the blade 1 and passing the airflow through the small grooves, such that the cut slices of the object B (such as the meat slices and the elastic objects) will not be attached onto the surface of the blade 1, so as to complete the cutting operation smoothly and successfully.

In summation of the description above, the present invention improves over the prior art and complies with the patent application requirements, and thus is duly filed for a patent application.

What is claimed is:

1. A knife assembly, comprising a blade provided for cutting an object and a handle provided for holding a knife, and a plurality of small grooves being engraved on a surface of the blade and disposed equidistantly with each other on a plurality of small sections of the blade, and upper and lower ends of the small grooves being extended to a knife back and a blade edge, such that if the knife is used for cutting an object, an airflow will be produced outside the surface of the blade, and the cut slices of the object will not be attached or adhered onto the surface of the blade, so as to achieve the effect of completing the cutting operation smoothly and successfully.
